(19) United States
(12) Patent Application Publication
(10) Pub. No.: US 2012/0275691 A1
(43) Pub. Date: Nov. 1, 2012

(54) COEFFICIENT LEARNING DEVICE AND METHOD, IMAGE PROCESSING DEVICE AND METHOD, PROGRAM, AND RECORDING MEDIUM

(75) Inventors: Kenichiro HOSOKAWA, Kanagawa (JP); Masashi Uchida, Tokyo (JP)

(73) Assignee: SONY CORPORATION, Tokyo (JP)

(21) Appl. No.: 13/448,702

(22) Filed: Apr. 17, 2012

(30) Foreign Application Priority Data
Apr. 26, 2011 (JP) 2011-098389

(51) Int. Cl. G06K 9/62; G06K 9/46

(52) U.S. Cl. 382/159; 382/192

(57) ABSTRACT

A feature-quantity extraction unit extracts a feature quantity of a target pixel of a student image. The target pixel is classified into a predetermined class. Natural-image processing of the target pixel is performed. Artificial-image processing of the target pixel is performed. A sample of a normal equation is generated using a pixel value of the target pixel subjected to the natural-image processing, a pixel value of the target pixel subjected to the artificial-image processing, a pixel value of a target pixel of a teacher image, and a predetermined mixing coefficient for each class. The mixing coefficient is calculated on the basis of a plurality of generated samples.

### BACKGROUND

The present technology relates to a coefficient learning device and method, an image processing device and method, a program, and a recording medium, and more particularly, to a coefficient learning device and method, an image processing device and method, a program, and a recording medium, which enable a plurality of regions of which characteristics are different to be appropriately classified in an image having the regions.

High image-quality processing has come into practical use in the related art. When the high image-quality processing is executed, it is necessary to execute a process suitable for an image in consideration of characteristics of the image and the like.

For example, portions included in an image may be classified into artificial and natural images. Here, the artificial images are artificial images such as text or simple graphics, exhibiting a small number of grayscale levels and distinct phase information indicating the positions of edges, that is, including many flat portions. In other words, the artificial image is defined as a portion (region) in an image in which the number of grayscale levels of text, simple graphics, or the like is small and information indicating a position such as a contour is dominant. In addition, the natural image is defined as a portion (region) in an image other than the artificial image, and, for example, corresponds to an image or the like obtained by directly imaging something in nature.

When the high image-quality processing is performed, a method of enabling a process for the natural image to be different from a process for the artificial image can obtain a higher effect because image characteristics are largely different between the artificial image and the natural image. On the other hand, because the image characteristics are largely different between the artificial image and the natural image, a problem becomes serious (and image quality is rather degraded) when a natural-image-specific process is applied to the artificial image or when an artificial-image-specific process is applied to the natural image.

That is, when high image-quality processing including the natural-image-specific process and the artificial-image-specific process is performed, it is necessary to accurately determine whether a target pixel of the image is a pixel of a portion to be classified into the natural image or the artificial image.

The applicant has proposed technology for distinguishing a region including an element that is a natural image in an image and a region including an element that is an artificial image from each other, applying an optimum process to each region, and accurately improving the entire image quality (for example, see Japanese Patent Application Laid-Open No. 2007-251687).

### SUMMARY

However, a threshold necessary for a determination is adjusted depending on human experience in Japanese Patent Application Laid-Open No. 2007-251687.

Thus, in the technology of Japanese Patent Application Laid-Open No. 2007-251687, there is a problem in that the number of steps for parameter adjustment is increased if the number of parameters to be considered is increased.

In addition, quantitative validity may be insufficient because it depends on human experience.

It is desirable to enable a plurality of regions of which characteristics are different to be appropriately classified in an image having the regions.

According to the first embodiment of the present technology, there is provided a coefficient learning device including a feature-quantity extraction unit for extracting a feature quantity of a target pixel of a student image, a class classification unit for classifying the target pixel into a predetermined class on the basis of the extracted feature quantity, a natural-image processing unit for performing natural-image processing including a process for restoring at least a pixel luminance level for the target pixel, an artificial-image processing unit for performing artificial-image processing including a process for making at least an edge clear for the target pixel. a sample generation unit for generating a sample of a normal equation using a pixel value of the target pixel subjected to the natural-image processing, a pixel value of the target pixel subjected to the artificial-image processing, a pixel value of a target pixel of a teacher image, and a predetermined mixing coefficient for each class, and a mixing-coefficient calculation unit for calculating the mixing coefficient on the basis of a plurality of generated samples.

The feature-quantity extraction unit extracts a wide-range feature quantity calculated on the basis of a dynamic range in a corresponding region around the target pixel in a relatively wide region, an adjacent pixel difference absolute value, and a maximum value of the adjacent pixel difference absolute value.

The feature-quantity extraction unit extracts a wide-range feature quantity calculated on the basis of a dynamic range in a corresponding region around the target pixel in a relatively wide region, an adjacent pixel difference absolute value, and a maximum value of the adjacent pixel difference absolute value, and extracts a narrow-range feature quantity calculated on the basis of the greatest value among a dynamic range in a relatively wide region around the target pixel and dynamic ranges of a plurality of relatively narrow regions including the target pixel.

According to the first embodiment of the present technology, there is provided a coefficient learning method including extracting, by a feature-quantity extraction unit, a feature quantity of a target pixel of a student image, classifying, by a class classification unit, the target pixel into a predetermined class on the basis of the extracted feature quantity, performing, by a natural-image processing unit, natural-image processing including a process for restoring at least a pixel luminance level for the target pixel, performing, by an artificial-image processing unit, artificial-image processing including a process for making at least an edge clear for the target pixel, generating, by a sample generation unit, a sample of a normal equation using a pixel value of the target pixel subjected to the natural-image processing, a pixel value of the target pixel subjected to the artificial-image processing, a pixel value of a target pixel of a teacher image, and a predetermined mixing coefficient for each class, and calculating, by a mixing-coefficient calculation unit, the mixing coefficient on the basis of a plurality of generated samples.

According to the first embodiment of the present technology, there is provided a program for causing a computer to function as a coefficient learning device including a feature-quantity extraction unit for extracting a feature quantity of a target pixel of a student image, a class classification unit for classifying the target pixel into a predetermined class on the basis of the extracted feature quantity, a natural-image processing unit for performing natural-image processing including a process for restoring at least a pixel luminance level for the target pixel, an artificial-image processing unit for performing artificial-image processing including a process for making at least an edge clear for the target pixel, a sample generation unit for generating a sample of a normal equation using a pixel value of the target pixel subjected to the natural-image processing, a pixel value of the target pixel subjected to the artificial-image processing, a pixel value of a target pixel of a teacher image, and a predetermined mixing coefficient for each class, and a mixing-coefficient calculation unit for calculating the mixing coefficient on the basis of a plurality of generated samples.

According to the first embodiment of the present technology, a feature quantity of a target pixel of a student image is extracted. The target pixel is classified into a predetermined class on the basis of the extracted feature quantity. Natural-image processing including a process for restoring at least a pixel luminance level is performed for the target pixel. Artificial-image processing including a process for making an edge clear is performed for the target pixel. A sample of a normal equation is generated using a pixel value of the target pixel subjected to the natural-image processing, a pixel value of the target pixel subjected to the artificial-image processing, a pixel value of a target pixel of a teacher image, and a predetermined mixing coefficient for each class. The mixing coefficient is calculated on the basis of a plurality of generated samples.

According to the second embodiment of the present technology, there is provided an image processing device including a feature-quantity extraction unit for extracting a feature quantity of a target pixel of an input image, a class classification unit for classifying the target pixel into a predetermined class on the basis of the extracted feature quantity, a natural-image processing unit for performing natural-image processing including a process for restoring at least a pixel luminance level for the target pixel, an artificial-image processing unit for performing artificial-image processing including a process for making at least an edge clear for the target pixel, and a pixel generation unit for generating a pixel of an output image by mixing a pixel value of the target pixel subjected to the natural-image processing and a pixel value of the target pixel subjected to the artificial-image processing using a mixing coefficient stored in association with the class.

The feature-quantity extraction unit extracts a wide-range feature quantity calculated on the basis of a dynamic range in a corresponding region around the target pixel in a relatively wide region, an adjacent pixel difference absolute value, and a maximum value of the adjacent pixel difference absolute value.

The feature-quantity extraction unit extracts a wide-range feature quantity calculated on the basis of a dynamic range in a corresponding region around the target pixel in a relatively wide region, an adjacent pixel difference absolute value, and a maximum value of the adjacent pixel difference absolute value, and extracts a narrow-range feature quantity calculated on the basis of a greatest value among a dynamic range in a relatively wide region around the target pixel and dynamic ranges of a plurality of relatively narrow regions including the target pixel.

The pixel generation unit performs weighted averaging on mixing coefficients corresponding to each of the classes to which the target pixel belongs and its peripheral class by weighting the mixing coefficients according to a distance between a vector obtained from a feature quantity of the target pixel and a center vector of the peripheral class, and generates the pixel of the output image through mixing using the mixing coefficient subjected to the weighted averaging.

According to the second embodiment of the present technology, there is provided an image processing method including extracting, by a feature-quantity extraction unit, a feature quantity of a target pixel of an input image, classifying, by a class classification unit, the target pixel into a predetermined class on the basis of the extracted feature quantity, performing, by a natural-image processing unit, natural-image processing including a process for restoring at least a pixel luminance level for the target pixel, performing, by an artificial-image processing unit, artificial-image processing including a process for making at least an edge clear for the target pixel, and generating, by a pixel generation unit, a pixel of an output image by mixing a pixel value of the target pixel subjected to the natural-image processing and a pixel value of the target pixel subjected to the artificial-image processing using a mixing coefficient stored in association with the class.

According to the second embodiment of the present technology, there is a program for causing a computer to function as an image processing device including a feature-quantity extraction unit for extracting a feature quantity of a target pixel of an input image, a class classification unit for classifying the target pixel into a predetermined class on the basis of the extracted feature quantity, a natural-image processing unit for performing natural-image processing including a process for restoring at least a pixel luminance level for the target pixel, an artificial-image processing unit for performing artificial-image processing including a process for making at least an edge clear for the target pixel, and a pixel generation unit for generating a pixel of an output image by mixing a pixel value of the target pixel subjected to the natural-image processing and a pixel value of the target pixel subjected to the artificial-image processing using a mixing coefficient stored in association with the class.

According to a second embodiment of the present technology, a feature quantity of a target pixel of an input image is extracted. The target pixel is classified into a predetermined class on the basis of the extracted feature quantity. Natural-image processing including a process for restoring at least a pixel luminance level is performed for the target pixel. Artificial-image processing including a process for making an edge clear is performed for the target pixel. A pixel of an output image is generated by mixing a pixel value of the target pixel subjected to the natural-image processing and a pixel value of the target pixel subjected to the artificial-image processing using a mixing coefficient stored in association with the class.

According to the embodiments of the present technology described above, it is possible to enable a plurality of regions of which characteristics are different to be appropriately classified in an image having the regions.

### BRIEF DESCRIPTION OF THE DRAWINGS

FIG. 1 is a block diagram illustrating a configuration example according to an embodiment of an image processing device to which the present technology is applied;

FIG. 2 is a diagram illustrating an example of a process of an artificial-image processing unit;

FIG. 3 is a diagram illustrating an example of a process of the artificial-image processing unit;

FIG. 4 is a diagram illustrating an example of a process of a natural-image processing unit;

FIG. 5 is a diagram illustrating an example of a process of the natural-image processing unit;

FIG. 6 is a block diagram illustrating a configuration example of a learning device corresponding to the image processing device of FIG. 1;

FIG. 7 is a graph illustrating an example of variation of a point value to be output according to a value of diffn/DR;

FIG. 8 is a diagram illustrating an example of a block extraction scheme when a narrow-range feature quantity is calculated;

FIG. 9 is a diagram illustrating an example in which a target pixel is positioned directly above a fine line;

FIG. 10 is a diagram illustrating an example in which a target pixel is positioned in a location that is not directly above a fine line;

FIG. 11 is a block diagram illustrating a detailed configuration example of a natural-image/artificial-image determination unit of FIG. 1;

FIG. 12 is a flowchart illustrating an example of a coefficient learning process;

FIG. 13 is a flowchart illustrating an example of high image-quality processing;

FIG. 14 is a flowchart illustrating an example of an artificial-image determination process;

FIG. 15 is a block diagram illustrating an example in which a result of a determination by the natural-image/artificial-image determination unit of FIG. 1 is used in another process; and

FIG. 16 is a block diagram illustrating a configuration example of a personal computer.

### DETAILED DESCRIPTION OF THE EMBODIMENT(S)

Hereinafter, preferred embodiments of the present technology will be described in detail with reference to the appended drawings. Note that, in this specification and the appended drawings, structural elements that have substantially the same function and structure are denoted with the same reference numerals, and repeated explanation of these structural elements is omitted.

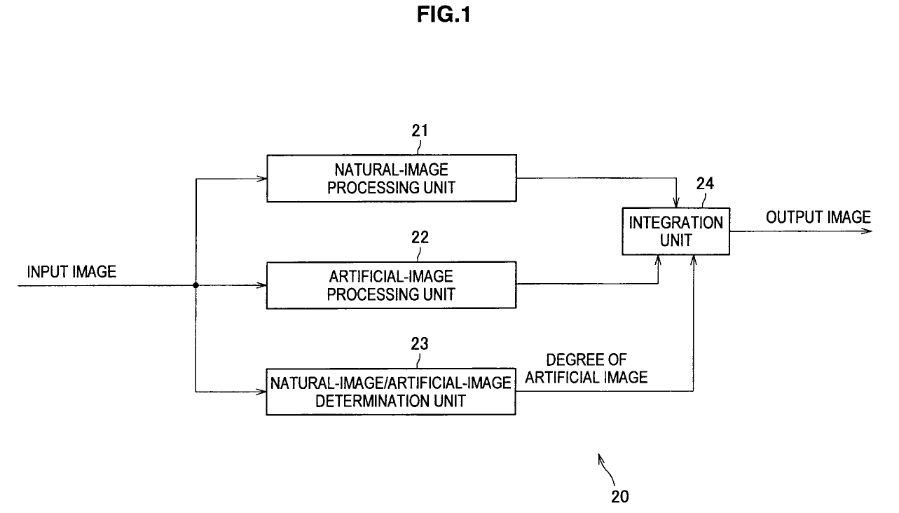

FIG. 1 is a block diagram illustrating a configuration example according to an embodiment of an image processing device to which the present technology is applied.

The image processing device 20 illustrated in the same drawing is configured to perform high image-quality processing of an input image and output the image subjected to the high image-quality processing as an output image. In this example, the image processing device 20 includes a natural-image processing unit 21, an artificial-image processing unit 22, a natural-image/artificial-image determination unit 23, and an integration unit 24.

The natural-image/artificial-image determination unit 23 determines whether each pixel of the input image is a pixel of a natural image or an artificial image. The natural-image/artificial-image determination unit 23 calculates a feature quantity corresponding to a target pixel on the basis of pixel values of the target pixel of the input image and its peripheral pixel. The natural-image/artificial-image determination unit 23 classifies the target pixel into a predetermined class on the basis of the calculated feature quantity, and determines whether the target pixel is the pixel of the natural image or the artificial image on the basis of a classification result.

Although details will be described later, a result of the determination by the natural-image/artificial-image determination unit 23 is adapted to be output as the degree of the artificial image of the target pixel.

The natural-image processing unit 21 is configured to execute the high image-quality processing of the target pixel determined to be the pixel of the natural image in the input image.

The artificial-image processing unit 22 is configured to execute the high image-quality processing of the target pixel determined to be the pixel of the artificial image in the input image.

Here, the artificial images are artificial images such as text or simple graphics, exhibiting a small number of grayscale levels and distinct phase information indicating the positions of edges, that is, including many flat portions. In other words, the artificial image is defined as a portion (region) in an image in which the number of grayscale levels of text, simple graphics, or the like is small and information indicating a position such as a contour is dominant. In addition, the natural image is defined as a portion (region) in an image other than the artificial image, and, for example, corresponds to an image or the like obtained by directly imaging something in nature.

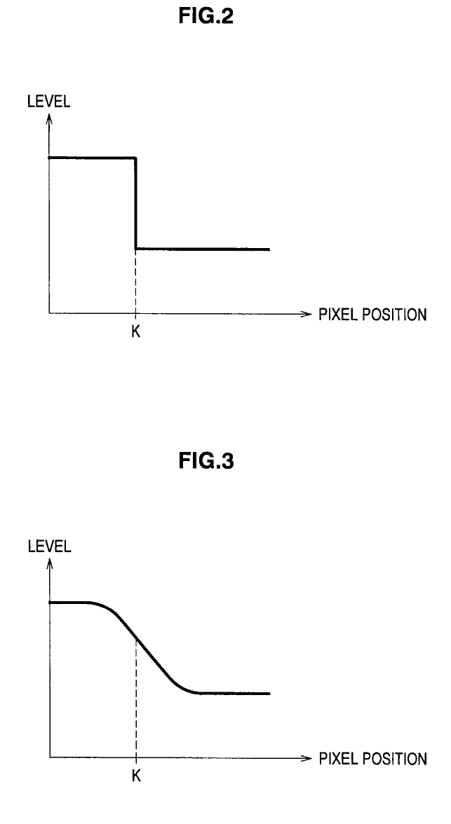

An example of the process of the artificial-image processing unit 22 will be described with reference to FIGS. 2 and 3.

FIG. 2 is a diagram illustrating an example of variation of a luminance level of a pixel of an edge portion in an extremely high-quality image (close to a real-life image). In the same drawing, the vertical axis represents a luminance level, the horizontal axis represents a pixel position in a horizontal direction, and a luminance level of each pixel is shown as a graph. In the example of FIG. 2, it can be seen that the luminance level is abruptly varied, and an edge is present, in a pixel position K.

FIG. 3 is a diagram illustrating an example of variation of a luminance level of a pixel when the same image as in FIG. 2 is captured by a camera and displayed on a display. In the same drawing, the vertical axis represents a luminance level, the horizontal axis represents a pixel position in a horizontal direction, and a luminance level of each pixel is shown as a graph. In the example of FIG. 3, unlike the case of FIG. 2, the luminance level is gradually varied around a pixel position K. That is, in the case of FIG. 3, it can be seen that image quality is degraded and therefore an edge portion of the image is unclearly displayed.

The artificial-image processing unit 22 is configured, for example, to execute a process of enabling the luminance level of each pixel as illustrated in FIG. 3 to be close to FIG. 2. In this example, a process is executed to increase and decrease luminance levels of a predetermined number of pixels positioned on the left of the pixel position K of FIG. 3. At this time, the above-described process is executed so that the luminance level is abruptly varied only in the pixel position K. In the process of the artificial-image processing unit 22, a phase of a waveform of a pixel value is appropriately taken and an edge is made clear without generating ringing or the like as described above.

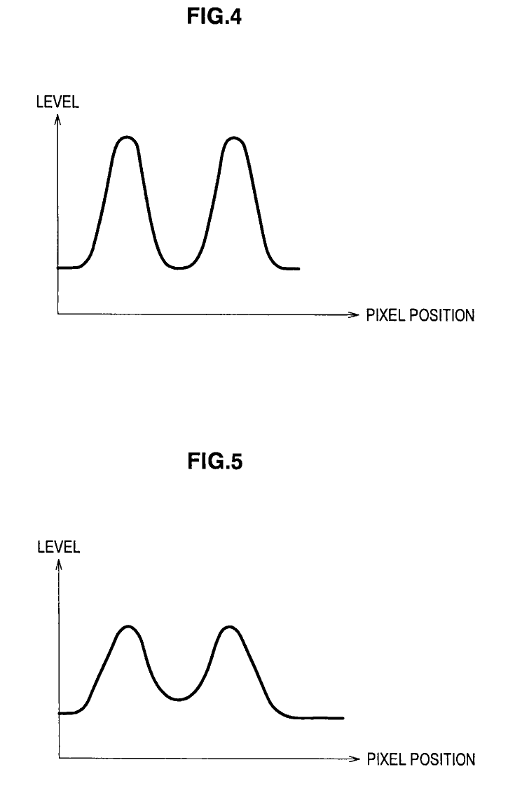

An example of the process of the natural-image processing unit 21 will be described with reference to FIGS. 4 and 5.

FIG. 4 is a diagram illustrating an example of variation of a luminance level of a pixel of a texture portion in an extremely high-quality image (close to a real-life image). In the same drawing, the vertical axis represents a luminance level, the horizontal axis represents a pixel position in a horizontal direction, and a luminance level of each pixel is shown as a graph. In the example of FIG. 4, it can be seen that two mountain-like shapes are formed and texture such as a pattern is present in the graph.

FIG. 5 is a diagram illustrating an example of variation of a luminance level of a pixel when the same image as in FIG. 4 is captured by a camera and displayed on a display. In the same drawing, the vertical axis represents a luminance level, the horizontal axis represents a pixel position in a horizontal direction, and a luminance level of each pixel is shown as a graph. In the example of FIG. 5, unlike the case of FIG. 4, a level of a mountain peak of the graph is low and a valley portion of the graph is also high. That is, in the case of FIG. 5, it can be seen that image quality is degraded and therefore a texture portion of the image is unclearly displayed.

The artificial-image processing unit 22 is configured, for example, to execute a process of enabling the luminance level of each pixel as illustrated in FIG. 5 to be close to FIG. 4. In this example, a process is executed to further increase variation in luminance levels of a predetermined number of pixels positioned in the mountain and valley portions of the graph of FIG. 5. In the process of the artificial-image processing unit 22, the luminance level of the pixel is adapted to be restored as described above.

As described above, the natural-image processing unit 21 and the artificial-image processing unit 22 are configured to execute different processes. Thus, for example, image quality is rather degraded if the process of the artificial-image processing unit 22 is performed for a pixel of a texture portion of an image, and image quality is rather degraded if the process of the natural-image processing unit 21 is performed for a pixel of an edge portion of an image. For example, in general, it is known that ringing occurs if the process of the natural-image processing unit 21 is executed for an edge pixel.

Returning to FIG. 1, a processing result of the natural-image processing unit 21 and a processing result of the artificial-image processing unit 22 are supplied to the integration unit 24.

The integration unit 24 is configured to improve image quality of a target pixel by mixing the processing result of the natural-image processing unit 21 and the processing result of the artificial-image processing unit 22 on the basis of the determination result of the natural-image/artificial-image determination unit 23, that is, the degree of the artificial image of the target pixel. An image constituted by pixels of improved image quality serves as an output image.

For example, when a luminance value (pixel value) of a pixel of the output image is denoted by Y, a pixel value of the processing result of the natural-image processing unit 21 is denoted by n, and a pixel value of the processing result of the artificial-image processing unit 22 is a, the integration unit 24 improves the image quality of the target pixel by calculating Equation (1).

Y=wa+(1−w)n (1)

In Equation (1), a coefficient w is the degree of the artificial image of the target pixel output as the determination result of the natural-image/artificial-image determination unit 23.

As described above, the image processing device 20 performs high image-quality processing of the input image.

As described above, the artificial image is a region in an image, such as text or simple graphics, exhibiting a small number of grayscale levels and distinct phase information indicating the positions of edges. The natural image is a region in an image other than the artificial image.

Accordingly, in the process of the natural-image processing unit 21, a waveform in which a luminance level is complexly varied in a space direction is assumed to be an input, and, for example, a texture region is a main object to be processed. In the artificial-image processing unit 22, a waveform in which phase information is important is assumed to be an input, and, for example, a main object to be processed is an edge.

However, this does not mean that all images referred to as, for example, computer graphics (CG) or a telop recalled from the term “artificial image” become regions to be processed by the artificial-image processing unit 22. In this regard, an example of a point or fine line will be described.

For example, if an artificial fine-line-like object (fine line) is displayed in an image of which a background is a monochromatic wall, an edge is around the object.

The edge is clearly made by appropriately taking a phase of a waveform of pixel values constituting an image at an edge that is a contour of a fine line and its periphery without generating ringing or the like, so that image quality can be improved. Thus, it is desirable to perform the process of the artificial-image processing unit 22 for the edge that is the contour of the fine line and its periphery.

On the other hand, it is possible to improve image quality by restoring a luminance level, for example, as in a pixel of a texture region, because a pixel directly above the fine line is likely to be degraded in a luminance-level direction, for example, in a process in which an image is captured and displayed. Thus, it is desirable to perform the process by the natural-image processing unit 21 suitable for restoring the luminance level for the pixel directly above the fine line.

Of course, it is desirable to perform the process of the artificial-image processing unit 22 for an edge and its periphery even when an object of a shape close to a point is displayed as in the above-described fine line. It is desirable to perform the process by the natural-image processing unit 21 for a pixel directly above a point.

In the present technology, the process by the natural-image processing unit 21 and the process of the artificial-image processing unit 22 are applied by distinguishing pixels of an edge and its periphery in an image and a pixel directly above a fine line or a point from each other.

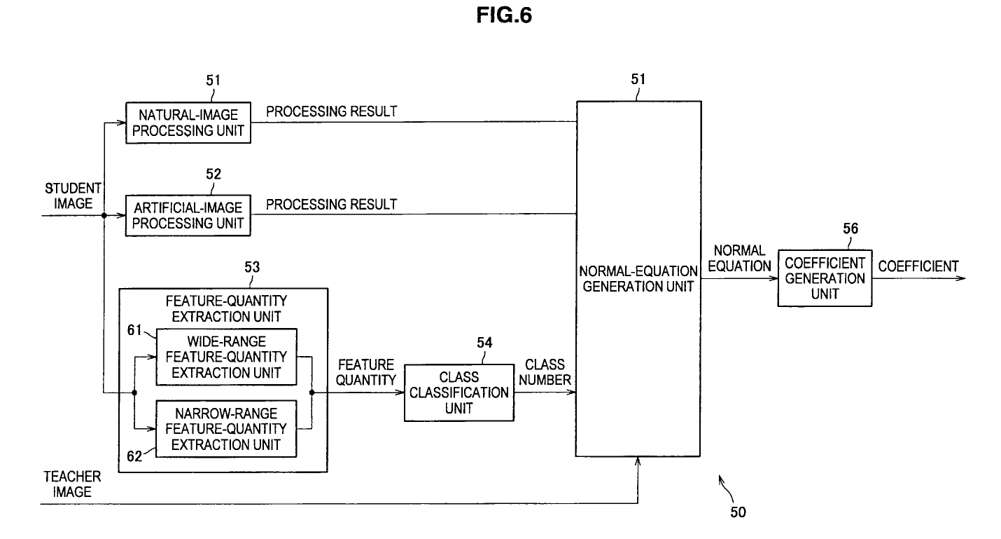

In addition, in the present technology, the coefficient w of the above-described Equation (1) is obtained by learning. FIG. 6 is a block diagram illustrating a configuration example of a learning device corresponding to the image processing device 20 of FIG. 1.

A learning device 50 of FIG. 6 is configured to have a natural-image processing unit 51, an artificial-image processing unit 52, a feature-quantity extraction unit 53, a class classification unit 54, a normal-equation generation unit 55, and a coefficient generation unit 56.

The learning device 50 is configured to designate an image of predetermined high image-quality as a teacher image, designate an image obtained by pre-degrading the quality of the teacher image as a student image, and obtain an optimum coefficient w by a calculation on the basis of pixels obtained by improving image equality of pixels of the teacher image and the student image.

Because the natural-image processing unit 51 and the artificial-image processing unit 52 have the same functional blocks as the natural-image processing unit 21 and the artificial-image processing unit 22, detailed description thereof is omitted.

The feature-quantity extraction unit 53 is configured to extract a feature quantity corresponding to a target pixel from the student image. The feature-quantity extraction unit 53 is configured to have a wide-range feature-quantity extraction unit 61 and a narrow-range feature-quantity extraction unit 62. A combination of feature quantities each extracted by the wide-range feature-quantity extraction unit 61 and the narrow-range feature-quantity extraction unit 62 is output to the class classification unit 54.

Details of the feature quantities extracted by the wide-range feature-quantity extraction unit 61 and the narrow-range feature-quantity extraction unit 62 will be described later.

The class classification unit 54 classifies target pixels into a plurality of preset classes, for example, on the basis of the feature quantities supplied from the feature-quantity extraction unit 53. The class classification unit 54 classifies the target pixels into the plurality of classes by analyzing the combination of the feature quantities each extracted by the wide-range feature-quantity extraction unit 61 and the narrow-range feature-quantity extraction unit 62 as a multi-dimensional vector, and dividing its multi-dimensional vector space by predetermined criteria. The class classification unit 54 is configured to output a class code indicating a class to which the target pixel belongs.

A pixel value of the target pixel processed by the natural-image processing unit 51, a pixel value of the target pixel processed by the artificial-image processing unit 52, a pixel value of the target pixel in the teacher image, and a class code of the target pixel output from the class classification unit 54 are input to the normal-equation generation unit 55.

The normal-equation generation unit 55 generates Equation (2) by designating the pixel value of the target pixel in the teacher image as “t,” designating a pixel value of a processing result of the natural-image processing unit 51 as “n,” and designating a pixel value of a processing result of the artificial-image processing unit 52 as “a.”

t=wa+(1−w)n (2)

If the coefficient w in Equation (2) is obtained, it is preferable that a square error (square of e) be minimized after substitution of each value into Equation (2) and modification as shown in Equation (3).

e²=(t−w(a−n)−n)² (3)

The normal-equation generation unit 55 is configured to accumulate Equation (3) for each class code as a sample. After sufficient samples are accumulated for classes, the coefficient w is calculated by a least square method as follows.

Equation (4) is derived from Equation (3).

$$\frac{\partial }{\partial w} {\sum }_{i = 1}^{sample} {e}^{2} = 2 {\sum }_{i = 1}^{sample} e \frac{\partial e}{\partial w} = 2 {\sum }_{i = 1}^{sample} ( {t}_{i} - w ( {a}_{i} - {n}_{i} ) - {n}_{i} ) ( {a}_{i} - {n}_{i} ) = 0 \qquad ( 4 )$$

Equation (5) can be generated from Equation (4).

$${\sum }_{i = 1}^{sample} ( {a}_{i} - {n}_{i} ) ( {t}_{i} - {n}_{i} ) = {\sum }_{i = 1}^{sample} {w ( {a}_{i} - {n}_{i} )}^{2} \qquad ( 5 )$$

For samples of Equations (4) and (5), the number of accumulated samples is indicated in the class code.

It is possible to obtain an optimum coefficient w in the class code by solving Equation (5) and obtaining the coefficient w.

The normal-equation generation unit 55 outputs a sample to the coefficient generation unit 56 when a predetermined number of samples of Equation (3) are accumulated for each class code.

The coefficient generation unit 56 calculates Equations (3) to (5) for each class code, and calculates the coefficient w corresponding to the class code. As described above, because the coefficient w is used when the processing result of the natural-image processing unit 21 and the processing result of the artificial-image processing unit 22 are mixed, it is referred to as an appropriate mixing coefficient.

A mixing coefficient calculated by the coefficient generation unit 56 is stored in association with a class code. The stored coefficient is used by the natural-image/artificial-image determination unit 23 as will be described later.

Next, the feature quantities extracted by the wide-range feature-quantity extraction unit 61 and the narrow-range feature-quantity extraction unit 62 will be described.

As described above, in the present technology, the process by the natural-image processing unit 21 and the process of the artificial-image processing unit 22 are applied by distinguishing pixels of an edge and its periphery in an image and a pixel directly above a fine line or a point from each other. Accordingly, it is necessary to sense whether or not an edge is around a target pixel and a flat portion is in the vicinity thereof and further sense whether the target pixel is directly above a fine line, a point, or the like or whether the target pixel is in a flat portion around the edge.

The wide-range feature-quantity extraction unit 61 extracts a wide-range feature quantity as a feature quantity for sensing whether or not the edge is around the target pixel and the flat portion is in the vicinity thereof. That is, the wide-range feature quantity is extracted so that it can be sensed whether an image around the target pixel is an image in which an artificial fine-line-like object (fine line) is displayed in an image of which a background is a monochromatic wall.

For example, in a relatively wide region (for example, a region constituted by (13×13) pixels), a feature quantity calculated on the basis of a dynamic range in a corresponding region around the target pixel, an adjacent pixel difference absolute value, and a maximum value of the adjacent pixel difference absolute value becomes a wide-range feature quantity.

An n-th adjacent pixel difference absolute value of the corresponding region is denoted by diffn (n=0, . . . , N). The adjacent pixel difference absolute value becomes a difference absolute value between luminance values of adjacent pixels and a maximum of N difference absolute values are present.

For example, as illustrated in Equation (6), the dynamic range in the corresponding region and each adjacent pixel difference absolute value are input as parameters, and a point p obtained as a sum of calculation results by a function f becomes a value of the wide-range feature quantity.

$$p = {\sum }_{n = 0}^{N} f ( DR , {diff}_{n} ) \qquad ( 6 )$$

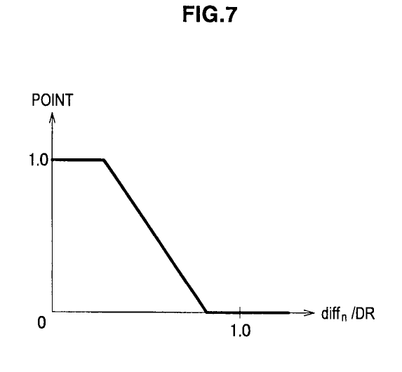

The function f of Equation (6) is adapted to output a value between 0 and 1 as a point and output a high point if each of adjacent pixel difference absolute values of the corresponding region is sufficiently small as compared to the dynamic range. The function f outputs a point, for example, as illustrated in FIG. 7.

In FIG. 7, the horizontal axis represents a ratio value between an adjacent pixel difference absolute value diffn and a dynamic range DR, the vertical axis represents a point value, and the variation in a point value output according to a value of diffn/DR is illustrated as a graph. Because a maximum value of diffn/DR is 1, the point has a minimum value of 0 when a value of the horizontal axis is 1. In addition, because a minimum value of diffn/DR is 0, the point has a maximum value of 1 when the value of the horizontal axis is 0. As illustrated in the graph of the same drawing, the point value is decreased when the value of diffn/DR is increased.

For example, if the point p obtained by Equation (6) is greater than or equal to a predetermined threshold, it is possible to determine that the edge is around the target pixel in the corresponding region and the flat portion is around the edge. If the corresponding region is an image of only the flat portion or if the corresponding region is an image of an iteration pattern or the like, the majority of diffn/DR is a value close to 1 and a value of the point p obtained by Equation (6) is also decreased.

The wide-range feature quantity may be extracted in a type other than that described here. In short, it is only necessary to determine whether or not the edge is around the target pixel in the corresponding region and the flat portion is in the vicinity thereof.

The narrow-range feature-quantity extraction unit 62 extracts a narrow-range feature quantity as a feature quantity for sensing whether the target pixel is directly above a fine line, a point, or the like or whether the target pixel is in a flat portion around an edge.

For example, the narrow-range feature-quantity extraction unit 62 can designate a value obtained by comparing dynamic ranges of regions of a plurality of different positions or areas including a target pixel as a narrow-range feature quantity.

For example, a pixel of a region constituted by (13×13) pixels around the target pixel is extracted and a dynamic range DR0 of the region is acquired.

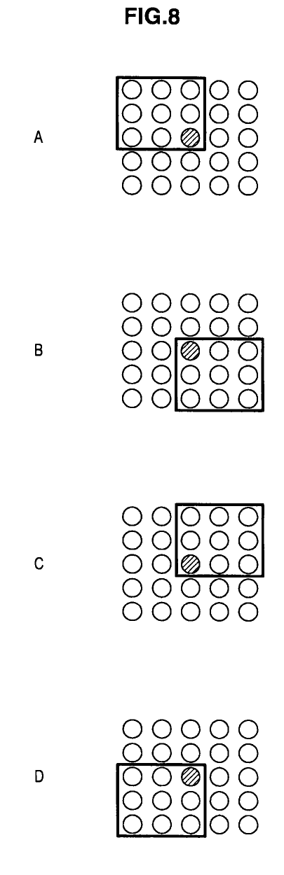

Further, the narrow-range feature-quantity extraction unit 62 extracts pixels of a block (relatively narrow region), for example, constituted by (3×3) pixels including the target pixel. In this case, a position of the target pixel within the block is varied, and, for example, four types of blocks of FIGS. 8A to 8D are extracted. In FIG. 8, a position of the target pixel is indicated by a hatched circle, and a position of a block is indicated by a heavy line in the drawing.

In the case of FIG. 8A, the target pixel is positioned at the bottom right of a block, and the narrow-range feature-quantity extraction unit 62 acquires a dynamic range DR1 of the block.

In addition, in the case of FIG. 8B, the target pixel is positioned at the top left of a block, and the narrow-range feature-quantity extraction unit 62 acquires a dynamic range DR2 of the block.

Further, in the case of FIG. 8C, the target pixel is positioned at the bottom left of a block, and the narrow-range feature-quantity extraction unit 62 acquires a dynamic range DR3 of the block.

In the case of FIG. 8D, the target pixel is positioned at the top right of a block, and the narrow-range feature-quantity extraction unit 62 acquires a dynamic range DR4 of the block.

The narrow-range feature-quantity extraction unit 62 selects a smallest value among DR1 to DR4. For example, DR4 is assumed to be selected as a smallest dynamic range value. The narrow-range feature-quantity extraction unit 62 calculates a ratio (DR4/DR0) between DR4 selected as the smallest dynamic range value and DR0.

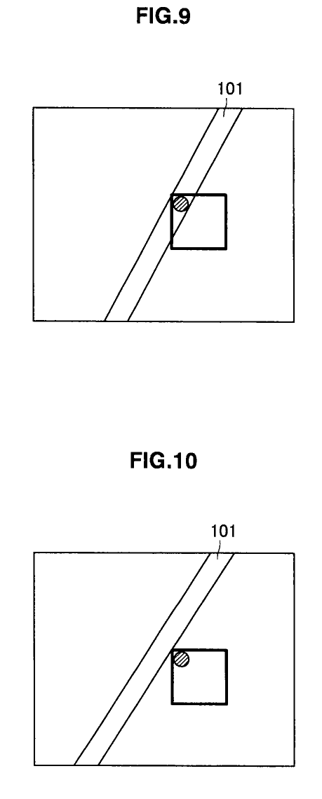

For example, when the target pixel is directly above a fine line 101 as illustrated in FIG. 9, a pixel of a fine line and a pixel of a background are included within the block (and an edge is included) even when a block of one of FIGS. 8A to 8D is extracted. Accordingly, a smallest value among DR1 to DR4 is close to a value of DR0.

FIG. 9 illustrates an example of a region of an image in which the fine line 101 is displayed. A position of the target pixel is indicated by a hatched circle in the drawing, and a position of a block is indicated by a heavy line in the drawing. In this example, the block illustrated in FIG. 8B is illustrated.

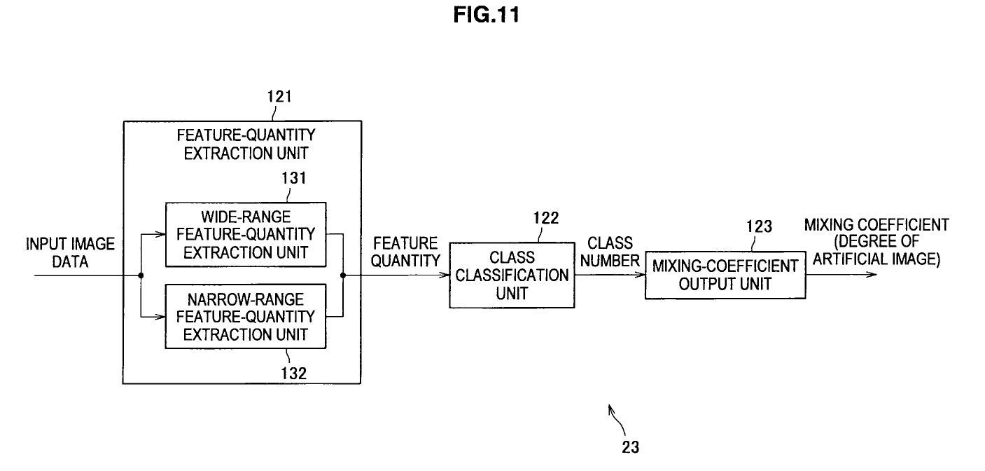

However, for example, as illustrated in FIG. 10, when the target pixel is positioned out of the fine line 101 even if only slightly, a block of at least one of FIGS. 8A to 8D is configured by only pixels of a background. Accordingly, a smallest value of DR1 to DR4 is sufficiently small as compared to a value of DR0.

Like FIG. 9, FIG. 10 illustrates an example of a region of an image in which the fine line 101 is displayed. A position of the target pixel is indicated by a hatched circle in the drawing, and a position of a block is indicated by a heavy line in the drawing. In this example, the block illustrated in FIG. 8B is illustrated. This block is configured by only pixels of a background.

Accordingly, a ratio between a smallest value selected from among DR1 to DR4 and DR0 can be extracted as a narrow-range feature quantity, and the target pixel can be determined to be directly above a fine line, a point, or the like if the narrow-range feature quantity is greater than or equal to a predetermined threshold. In this case, the smallest value of DR1 to DR4 is assumed to be close to a value of DR0, and an edge may be included in any of the four types of the blocks of FIG. 8.

As described above, it is possible to sense whether the target pixel is directly above a fine line, a point, or the like or whether the target pixel is in a flat portion around an edge by comparing the narrow-range feature quantity with the threshold. However, it is assumed that it can be determined that an edge is around the target pixel in a corresponding region and a flat portion is in the vicinity thereof on the basis of the wide-range feature quantity of the target pixel.

The narrow-range feature quantity may be extracted in a type other than that described here. For example, an edge may be extracted by a filtering operation of a Sobel filter or the like and generated as a feature quantity. In short, it is only necessary to determine whether the target pixel is directly above a fine line, a point, or the like or whether the target pixel is in a flat portion around an edge.

As described above, the wide-range feature quantity and the narrow-range feature quantity are extracted. As described above, a combination of the wide-range feature quantity and the narrow-range feature quantity is output to the class classification unit 54, and the class classification unit 54 classifies target pixels into a plurality of preset classes, for example, on the basis of the combination of the wide-range feature quantity and the narrow-range feature quantity.

As described above, a mixing coefficient is learned.

FIG. 11 is a diagram illustrating a detailed configuration example of the natural-image/artificial-image determination unit 23 of FIG. 1. In the example of the same drawing, the natural-image/artificial-image determination unit 23 is constituted by a feature-quantity extraction unit 121, a class classification unit 122, and a mixing-coefficient output unit 123. In addition, the feature-quantity extraction unit 121 is configured to have a wide-range feature-quantity extraction unit 131 and a narrow-range feature-quantity extraction unit 132.

The natural-image/artificial-image determination unit 23 of FIG. 11 is configured to output a value (mixing coefficient) indicating a degree of an artificial image of each target pixel, for example, while setting the target pixel in the input image and shifting a position of the target pixel in raster scanning or the like.

The input image is initially supplied to the feature-quantity extraction unit 121, and a feature quantity corresponding to the target pixel is extracted from a student image. Like the wide-range feature-quantity extraction unit 61, the wide-range feature-quantity extraction unit 131 extracts a wide-range feature quantity as a feature quantity for sensing whether or not an edge is around a target pixel and a flat portion is in the vicinity thereof. In addition, like the narrow-range feature-quantity extraction unit 62, the narrow-range feature-quantity extraction unit 132 extracts a narrow-range feature quantity as a feature quantity for sensing whether the target pixel is directly above a fine line, a point, or the like or whether the target pixel is in a flat portion around an edge.

The combination of the wide-range feature quantity and the narrow-range feature quantity is configured to be output to the class classification unit 122.

Like the class classification unit 54, the class classification unit 122 classifies target pixels into a plurality of preset classes, for example, on the basis of a feature quantity supplied from the feature-quantity unit 121. The class classification unit 122 classifies the target pixels into the plurality of classes by analyzing the combination of the wide-range feature quantity and the narrow-range feature quantity as a multi-dimensional vector and dividing a multi-dimensional vector space by predetermined criteria. The class classification unit 122 is configured to output a class code indicating a class to which the target pixel belongs.

A mixing coefficient of each class code obtained as a learning result of the learning device 50 of FIG. 6 is pre-stored in the mixing-coefficient output unit 123. The mixing-coefficient output unit 123 outputs a mixing coefficient stored in association with the class code supplied from the class classification unit 122. Thereby, the degree of the artificial image of the target pixel is output.

Alternatively, the mixing-coefficient output unit 123 may output a mixing coefficient as follows. For example, the mixing-coefficient output unit 123 extracts a predetermined number of (for example, M) mixing coefficients corresponding to a class to which a vector obtained from a feature quantity of a target pixel belongs and a class of its periphery in the above-described multi-dimensional vector space. The mixing-coefficient output unit 123 may perform weighting according to a distance between a vector obtained from a feature quantity of the target pixel and a center vector of a peripheral class, and output a weighted average of a coefficient of each class by weighted averaging.

For example, a mixing coefficient after the weighted averaging is denoted by wₒᵤₜ, a vector obtained from the feature quantity of the target pixel is denoted by p, a center vector of an i-th class among peripheral classes is denoted by cᵢ, and a mixing coefficient associated with the i-th class is denoted by wᵢ. In this case, the mixing coefficient wₒᵤₜ to be obtained is calculated by Equation (7).

$${w}_{out} = {\sum }_{i = 0}^{M} f ( p , {c}_{i} ) {w}_{i} \qquad ( 7 )$$

As described above, the mixing coefficient may be output.

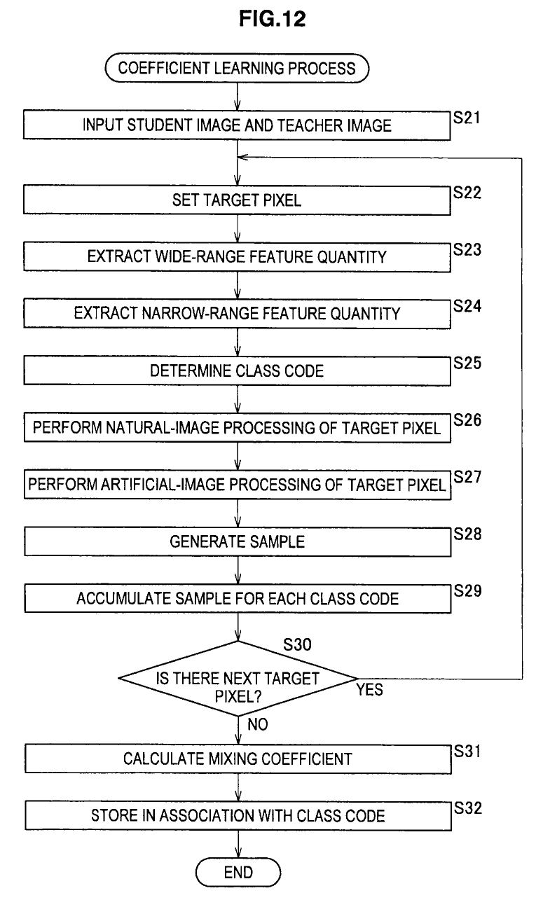

Next, an example of a learning process by the learning device 50 of FIG. 6 will be described with reference to the flowchart of FIG. 12.

In step S21, a teacher image and a student image are input.

In step S22, a target pixel is set.

In step S23, the wide-range feature-quantity extraction unit 61 extracts a wide-range feature quantity as a feature quantity for sensing whether or not the edge is around the target pixel and the flat portion is in the vicinity thereof. That is, the wide-range feature quantity is extracted, for example, so that it can be sensed whether an image around the target pixel is an image in which an artificial fine-line-like object (fine line) is displayed in an image of which a background is a monochromatic wall.

At this time, for example, as described above, in a relatively wide region (for example, a region constituted by (13×13) pixels), a feature quantity calculated on the basis of a dynamic range in a corresponding region around the target pixel, an adjacent pixel difference absolute value, and a maximum value of the adjacent pixel difference absolute value is extracted as a wide-range feature quantity. For example, as illustrated in Equation (6), the dynamic range in the corresponding region and each adjacent pixel difference absolute value are input as parameters, and a point p obtained as a sum of calculation results by a function f is extracted as a value of the wide-range feature quantity.

In step S24, the narrow-range feature-quantity extraction unit 62 extracts a narrow-range feature quantity as a feature quantity for sensing whether the target pixel is directly above a fine line, a point, or the like or whether the target pixel is in a flat portion around an edge.

At this time, for example, a pixel of a region constituted by (13×13) pixels around the target pixel is extracted and a dynamic range DR0 of the region is acquired. Further, pixels of a block constituted by (3×3) pixels including the target pixel are extracted and dynamic ranges DR1 to DR4 of each block are acquired. A ratio between a smallest value selected from among DR1 to DR4 and DR0 is extracted as a narrow-range feature quantity.

In step S25, the class classification unit 54 determines a class code on the basis of a combination of feature quantities extracted in the process of steps S23 and S24.

At this time, for example, the target pixels are classified into the plurality of classes by analyzing the combination of the wide-range feature quantity and the narrow-range feature quantity as a multi-dimensional vector and dividing a multi-dimensional vector space by predetermined criteria. The class classification unit 54 outputs a class code indicating a class to which the target pixel belongs.

In step S26, the natural-image processing unit 51 processes the target pixel. At this time, for example, as described above with reference to FIGS. 4 and 5, a process of improving image quality by restoring a luminance level is executed for a target pixel.

In step S27, the artificial-image processing unit 52 processes the target pixel. At this time, for example, as described with reference to FIGS. 2 and 3, a phase of a waveform of pixel values constituting an image is appropriately taken and the edge is clearly made without generating ringing or the like, so that high image-quality processing is executed for a target pixel.

In step S28, the normal-equation generation unit 55 generates a sample.

At this time, the normal-equation generation unit 55 designates the pixel value of the target pixel in the teacher image as “t,” designates a pixel value of a processing result of the natural-image processing unit 51 as “n,” designates a pixel value of a processing result of the artificial-image processing unit 52 as “a,” generates Equation (2), and generates Equation (3) as a sample.

In step S29, the normal-equation generation unit 55 accumulates the sample generated in the process of step S28 for each class code determined in the process of step S25.

It is determined whether or not there is the next target pixel in step S30. If the next target pixel is determined to be present, the process returns to step S22 and the subsequent process is iterated.

On the other hand, if the next target pixel is determined to be absent in step S30, the process proceeds to step S31.

Alternatively, in step S30, it may be determined whether or not sufficient samples have been accumulated for each class.

In step S31, the coefficient generation unit 56 calculates a mixing coefficient on the basis of the samples accumulated in the process of step S29.

At this time, the coefficient generation unit 56 carries out, for example, calculations of Equations (3) to (5) for each class code and calculates a mixing coefficient w corresponding to the class code.

In step S32, the coefficient generation unit 56 stores the mixing coefficient calculated in the process of step S31 in association with the class code.

As described above, a coefficient learning process is executed.

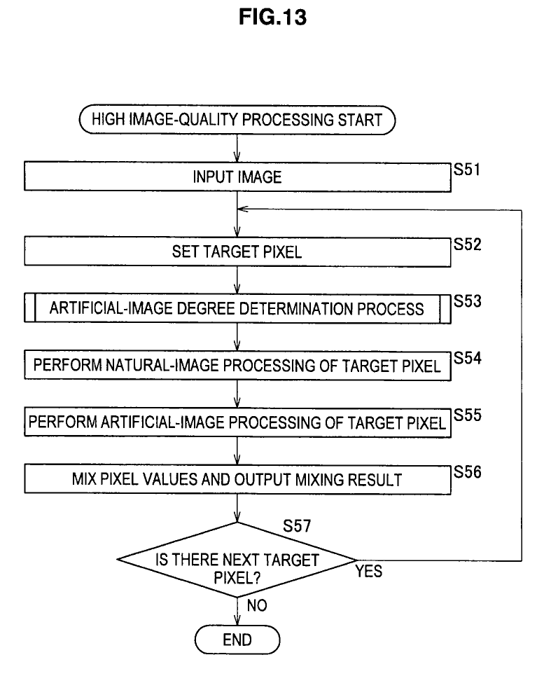

Next, an example of high image-quality processing by the image processing device 20 of FIG. 1 will be described with reference to FIG. 13. Before this process is executed, the mixing coefficient stored in the process of step S32 of FIG. 12 is copied to an internal memory of the mixing-coefficient output unit 123 of FIG. 11, or the like.

In step S51, an image serving as an object to be processed by high image-quality processing is input.

In step S52, a target pixel of an image input in step S51 is set.

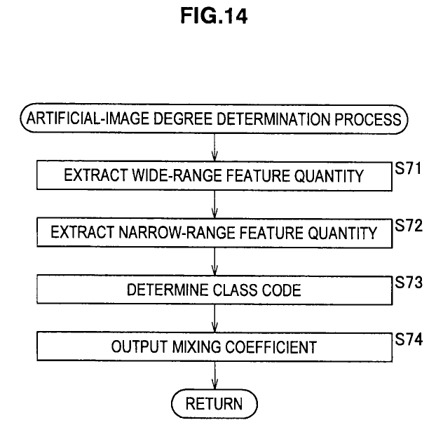

In step S53, the natural-image/artificial-image determination unit 23 executes an artificial-image degree determination process to be described later with reference to the flowchart of FIG. 14. Thereby, a mixing coefficient is output.

In step S54, the natural-image processing unit 21 processes a target pixel. At this time, for example, a process of performing high image-quality processing of an image by restoring a luminance level is executed for a target pixel as described above with reference to FIGS. 4 and 5.

In step S55, the artificial-image processing unit 22 processes the target pixel. At this time, for example, as described with reference to FIGS. 2 and 3, a phase of a waveform of pixel values constituting an image is appropriately taken and the edge is made clear without generating ringing or the like, so that high image-quality processing is executed for a target pixel.

In step S56, the integration unit 24 mixes a processing result of step S54 and a processing result of step S55 on the basis of a mixing coefficient output in the process of step S53, and outputs a mixing result. That is, image quality of the target pixel is improved by carrying out a calculation of the above-described Equation (1).

In step S57, it is determined whether or not there is the next target pixel. If the next target pixel is determined to be present, the process returns to step S52, and the subsequent process is iterated.

On the other hand, in step S57, if the next target pixel is determined to be absent, high image-quality processing ends.

As described above, the high image-quality processing is executed.

Next, a detailed example of the artificial-image degree determination process of step S53 of FIG. 13 will be described with reference to the flowchart of FIG. 14.

In step S71, the wide-range feature-quantity extraction unit 131 extracts a feature quantity for sensing whether or not an edge is around a target pixel set in the process of step S52 and a flat portion is in the vicinity thereof as a wide-range feature quantity.

At this time, for example, as described above, in a relatively wide region (for example, a region constituted by (13×13) pixels), a feature quantity calculated on the basis of a dynamic range in a corresponding region around the target pixel, an adjacent pixel difference absolute value, and a maximum value of the adjacent pixel difference absolute value is extracted as a wide-range feature quantity. For example, as illustrated in Equation (6), the dynamic range in the corresponding region and each adjacent pixel difference absolute value are input as parameters, and a point p obtained as a sum of calculation results by a function f becomes a value of the wide-range feature quantity.

In step S72, the narrow-range feature-quantity extraction unit 132 extracts a narrow-range feature quantity as a feature quantity for sensing whether the target pixel is directly above a fine line, a point, or the like or whether the target pixel is in a flat portion around an edge.

At this time, for example, a pixel of a region constituted by (13×13) pixels around the target pixel is extracted and a dynamic range DR0 of the region is acquired. Further, pixels of a block constituted by (3×3) pixels including the target pixel are extracted and dynamic ranges DR1 to DR4 of each block are acquired. A ratio between a smallest value selected from among DR1 to DR4 and DR0 is extracted as a narrow-range feature quantity.

In step S73, the class classification unit 122 classifies the target pixels into the plurality of preset classes, for example, on the basis of the combination of the wide-range feature quantity extracted in the process of step S71 and the narrow-range feature quantity extracted in the process of step S72. The class classification unit 122 determines and outputs a class code indicating a class to which the target pixel belongs.

In step S74, the mixing-coefficient output unit 123 outputs a mixing coefficient stored in association with the class code determined in the process of step S73. Thereby, the degree of the artificial image of the target pixel is output.

A calculation result by Equation (7) may be output as a mixing coefficient.

As described above, the artificial-image degree determination process is executed.

When high image-quality processing is performed, a method of enabling a process for the natural image to be different from a process for the artificial image can obtain a higher effect because image characteristics are largely different between the artificial image and the natural image. On the other hand, because the image characteristics are largely different between the artificial image and the natural image, a problem becomes serious (and image quality is rather degraded) when a natural-image-specific process is applied to the artificial image or when an artificial-image-specific process is applied to the natural image.

That is, when high image-quality processing including the natural-image-specific process and the artificial-image-specific process is performed, it is necessary to accurately determine whether a target pixel of the image is a pixel of a portion to be classified into the natural image or the artificial image.

In the related art, a threshold necessary to determine whether an image is classified into the natural image or the artificial image is adjusted, for example, depending on human experience.

Thus, in the related art, the number of steps for parameter adjustment is increased if the number of parameters to be considered is increased.

In addition, for the threshold adjustment in the related art, quantitative validity may be insufficient because it depends on human experience.

On the other hand, in the present technology, it is possible to secure quantitative validity because the mixing coefficient is obtained by learning as described above. In addition, because a target pixel is classified using the wide-range feature quantity and the narrow-range feature quantity, this is different from the case where an edge or texture is simply detected and classified. It is possible to appropriately classify a pixel to be truly processed by a process of the artificial-image processing unit and a pixel to be truly processed by a process of the natural-image processing unit.

According to the present technology, it is possible to appropriately classify a plurality of regions of which characteristics are different in an image having the regions.

When classifying a target pixel, although an example in which the target pixel is classified on the basis of a wide-range feature quantity and a narrow-range feature quantity has been described above, the target pixel may be classified, for example, on the basis of only the wide-range feature quantity.

Incidentally, an example in which the integration unit 24 mixes the processing result of the natural-image processing unit 21 and the processing result of the artificial-image processing unit 22 on the basis of the determination result by the natural-image/artificial-image determination unit 23 in FIG. 1 has been described. However, the determination result by the natural-image/artificial-image determination unit 23 may be used in another process.

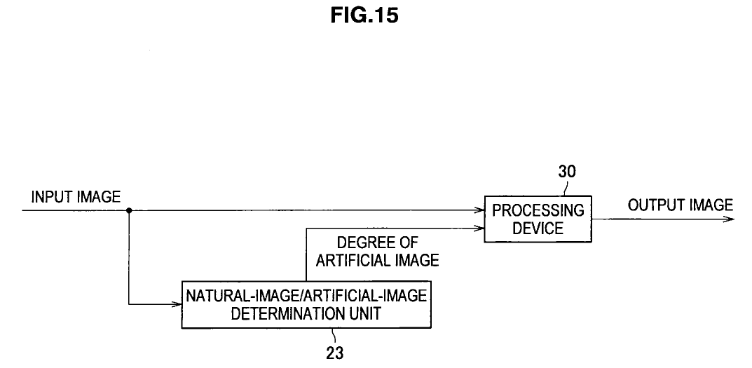

For example, as illustrated in FIG. 15, the determination result by the natural-image/artificial-image determination unit 23 may be supplied to a processing device 30 that executes independent image processing on the basis of the degree of the artificial image of an image. The processing device 30 executes a process of marking a frame of a corresponding screen, for example, on the basis of the degree of the artificial image of each target pixel within the screen.

As described above, for example, the effect of the present technology can be obtained even when the natural-image/artificial-image determination unit 23 is used as an independent device.

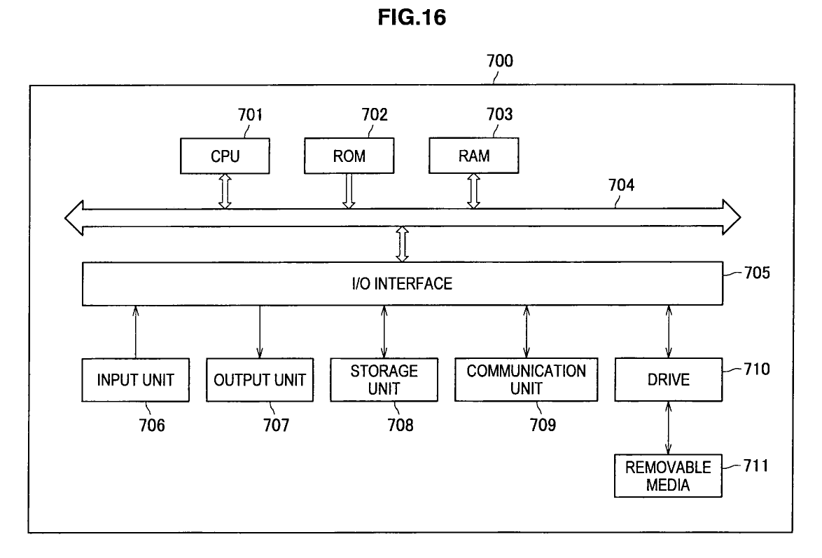

The above-described series of processes can be executed by hardware or software. When the above-described series of processes is executed by the software, a program constituting the software is installed from a network or a recording medium to a computer built in dedicated hardware or a general-purpose personal computer 700, for example, which can execute various functions by installing various programs, or the like, as illustrated in FIG. 16.

In FIG. 16, a central processing unit (CPU) 701 executes various processes according to a program stored in a read only memory (ROM) 702 or a program loaded from a storage unit 708 to a random access memory (RAM) 703. In addition, data or the like necessary for executing various processes by the CPU 701 is appropriately stored in the RAM 703.

The CPU 701, the ROM 702, and the RAM 703 are connected to each other via a bus 704. In addition, this bus 704 is also connected to an input/output (I/O) interface 705.

An input unit 706 including a keyboard, a mouse or the like, an output unit 707 including a display such as a liquid crystal display (LCD), a speaker or the like, a storage unit 708 including a hard disk or the like, and a communication unit 709 including a modem, a network interface card such as a local area network (LAN) card, or the like are connected to the I/O interface 705. The communication unit 709 performs a communication process through a network such as the Internet.

If necessary, a drive 710 is connected to the I/O interface 705, removable media 711 such as a magnetic disk, an optical disc, a magneto-optical disc or a semiconductor memory are appropriately mounted, and a computer program read therefrom is installed in the storage unit 708, if necessary.

If the above-described series of processes is executed by software, a program constituting the software is installed from a network such as the Internet or recording media including the removable media 711 and the like.

This recording medium includes, for example, as illustrated in FIG. 16, the removable media 711 including a magnetic disk (including a floppy disk (registered trademark), an optical disc (including a compact disc-read only memory (CD-ROM) or a digital versatile disc (DVD)), a magneto-optical disc (mini disc (MD) (registered trademark)), a semiconductor memory, or the like recording a program distributed to be delivered to a user, separately from a device body. Also, the recording medium includes the ROM 702 recording a program to be delivered to a user in a state in which it is built in the device body in advance, or a hard disk included in the storage unit 708.

The series of processes described in this specification includes processes to be executed in time series in the described order and processes to be executed in parallel or individually, not necessarily in time series.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

A coefficient learning device including:

a feature-quantity extraction unit for extracting a feature quantity of a target pixel of a student image;

a class classification unit for classifying the target pixel into a predetermined class on the basis of the extracted feature quantity;

a natural-image processing unit for performing natural-image processing including a process for restoring at least a pixel luminance level for the target pixel;

an artificial-image processing unit for performing artificial-image processing including a process for making at least an edge clear for the target pixel;

a sample generation unit for generating a sample of a normal equation using a pixel value of the target pixel subjected to the natural-image processing, a pixel value of the target pixel subjected to the artificial-image processing, a pixel value of a target pixel of a teacher image, and a predetermined mixing coefficient for each class; and

a mixing-coefficient calculation unit for calculating the mixing coefficient on the basis of a plurality of generated samples.

(2)

The coefficient learning device according to (1), wherein the feature-quantity extraction unit extracts a wide-range feature quantity calculated on the basis of a dynamic range in a corresponding region around the target pixel in a relatively wide region, an adjacent pixel difference absolute value, and a maximum value of the adjacent pixel difference absolute value.

(3)

The coefficient learning device according to (1), wherein the feature-quantity extraction unit

extracts a wide-range feature quantity calculated on the basis of a dynamic range in a corresponding region around the target pixel in a relatively wide region, an adjacent pixel difference absolute value, and a maximum value of the adjacent pixel difference absolute value, and

extracts a narrow-range feature quantity calculated on the basis of the greatest value among a dynamic range in a relatively wide region around the target pixel and dynamic ranges of a plurality of relatively narrow regions including the target pixel.

(4)

A coefficient learning method including:

extracting, by a feature-quantity extraction unit, a feature quantity of a target pixel of a student image;

classifying, by a class classification unit, the target pixel into a predetermined class on the basis of the extracted feature quantity;

performing, by a natural-image processing unit, natural-image processing including a process for restoring at least a pixel luminance level for the target pixel;

performing, by an artificial-image processing unit, artificial-image processing including a process for making at least an edge clear for the target pixel;

generating, by a sample generation unit, a sample of a normal equation using a pixel value of the target pixel subjected to the natural-image processing, a pixel value of the target pixel subjected to the artificial-image processing, a pixel value of a target pixel of a teacher image, and a predetermined mixing coefficient for each class; and

calculating, by a mixing-coefficient calculation unit, the mixing coefficient on the basis of a plurality of generated samples.

(5)

A program for causing a computer to function as a coefficient learning device including:

a feature-quantity extraction unit for extracting a feature quantity of a target pixel of a student image;

a class classification unit for classifying the target pixel into a predetermined class on the basis of the extracted feature quantity;

a natural-image processing unit for performing natural-image processing including a process for restoring at least a pixel luminance level for the target pixel;

an artificial-image processing unit for performing artificial-image processing including a process for making at least an edge clear for the target pixel;

a sample generation unit for generating a sample of a normal equation using a pixel value of the target pixel subjected to the natural-image processing, a pixel value of the target pixel subjected to the artificial-image processing, a pixel value of a target pixel of a teacher image, and a predetermined mixing coefficient for each class; and

a mixing-coefficient calculation unit for calculating the mixing coefficient on the basis of a plurality of generated samples.

(6)

A recording medium storing the program of (5).

(7)

An image processing device including:

a feature-quantity extraction unit for extracting a feature quantity of a target pixel of an input image;

a class classification unit for classifying the target pixel into a predetermined class on the basis of the extracted feature quantity;

a natural-image processing unit for performing natural-image processing including a process for restoring at least a pixel luminance level for the target pixel;

an artificial-image processing unit for performing artificial-image processing including a process for making at least an edge clear for the target pixel; and

a pixel generation unit for generating a pixel of an output image by mixing a pixel value of the target pixel subjected to the natural-image processing and a pixel value of the target pixel subjected to the artificial-image processing using a mixing coefficient stored in association with the class.

(8)

The image processing device according to (7), wherein the feature-quantity extraction unit extracts a wide-range feature quantity calculated on the basis of a dynamic range in a corresponding region around the target pixel in a relatively wide region, an adjacent pixel difference absolute value, and a maximum value of the adjacent pixel difference absolute value.

(9)

The image processing device according to (7), wherein the feature-quantity extraction unit

extracts a wide-range feature quantity calculated on the basis of a dynamic range in a corresponding region around the target pixel in a relatively wide region, an adjacent pixel difference absolute value, and a maximum value of the adjacent pixel difference absolute value, and

extracts a narrow-range feature quantity calculated on the basis of a greatest value among a dynamic range in a relatively wide region around the target pixel and dynamic ranges of a plurality of relatively narrow regions including the target pixel.

(10)

The image processing device according to any one of (7) to (9), wherein the pixel generation unit

performs weighted averaging on mixing coefficients corresponding to each of the classes to which the target pixel belongs and its peripheral class by weighting the mixing coefficients according to a distance between a vector obtained from a feature quantity of the target pixel and a center vector of the peripheral class, and

generates the pixel of the output image through mixing using the mixing coefficient subjected to the weighted averaging.

(11)

An image processing method including:

extracting, by a feature-quantity extraction unit, a feature quantity of a target pixel of an input image;

classifying, by a class classification unit, the target pixel into a predetermined class on the basis of the extracted feature quantity;

performing, by a natural-image processing unit, natural-image processing including a process for restoring at least a pixel luminance level for the target pixel;

performing, by an artificial-image processing unit, artificial-image processing including a process for making at least an edge clear for the target pixel; and

generating, by a pixel generation unit, a pixel of an output image by mixing a pixel value of the target pixel subjected to the natural-image processing and a pixel value of the target pixel subjected to the artificial-image processing using a mixing coefficient stored in association with the class.

(12)

A program for causing a computer to function as an image processing device including:

a feature-quantity extraction unit for extracting a feature quantity of a target pixel of an input image;

a class classification unit for classifying the target pixel into a predetermined class on the basis of the extracted feature quantity;

a natural-image processing unit for performing natural-image processing including a process for restoring at least a pixel luminance level for the target pixel;

an artificial-image processing unit for performing artificial-image processing including a process for making at least an edge clear for the target pixel; and

a pixel generation unit for generating a pixel of an output image by mixing a pixel value of the target pixel subjected to the natural-image processing and a pixel value of the target pixel subjected to the artificial-image processing using a mixing coefficient stored in association with the class.

(13)

A recording medium storing the program of (12).

The present disclosure contains subject matter related to that disclosed in Japanese Priority Patent Application JP 2011-098389 filed in the Japan Patent Office on Apr. 26, 2011, the entire content of which is hereby incorporated by reference.

What is claimed is:

1. A coefficient learning device comprising:
a feature-quantity extraction unit for extracting a feature quantity of a target pixel of a student image;
a class classification unit for classifying the target pixel into a predetermined class on the basis of the extracted feature quantity;
a natural-image processing unit for performing natural-image processing including a process for restoring at least a pixel luminance level for the target pixel;
an artificial-image processing unit for performing artificial-image processing including a process for making at least an edge clear for the target pixel;
a sample generation unit for generating a sample of a normal equation using a pixel value of the target pixel subjected to the natural-image processing, a pixel value of the target pixel subjected to the artificial-image processing, a pixel value of a target pixel of a teacher image, and a predetermined mixing coefficient for each class; and
a mixing-coefficient calculation unit for calculating the mixing coefficient on the basis of a plurality of generated samples.

2. The coefficient learning device according to claim 1, wherein the feature-quantity extraction unit extracts a wide-range feature quantity calculated on the basis of a dynamic range in a corresponding region around the target pixel in a relatively wide region, an adjacent pixel difference absolute value, and a maximum value of the adjacent pixel difference absolute value.

3. The coefficient learning device according to claim 1, wherein the feature-quantity extraction unit
extracts a wide-range feature quantity calculated on the basis of a dynamic range in a corresponding region around the target pixel in a relatively wide region, an adjacent pixel difference absolute value, and a maximum value of the adjacent pixel difference absolute value, and
extracts a narrow-range feature quantity calculated on the basis of the greatest value among a dynamic range in a relatively wide region around the target pixel and dynamic ranges of a plurality of relatively narrow regions including the target pixel.

4. A coefficient learning method comprising:
extracting, by a feature-quantity extraction unit, a feature quantity of a target pixel of a student image;
classifying, by a class classification unit, the target pixel into a predetermined class on the basis of the extracted feature quantity;
performing, by a natural-image processing unit, natural-image processing including a process for restoring at least a pixel luminance level for the target pixel;
performing, by an artificial-image processing unit, artificial-image processing including a process for making at least an edge clear for the target pixel;
generating, by a sample generation unit, a sample of a normal equation using a pixel value of the target pixel subjected to the natural-image processing, a pixel value of the target pixel subjected to the artificial-image processing, a pixel value of a target pixel of a teacher image, and a predetermined mixing coefficient for each class; and
calculating, by a mixing-coefficient calculation unit, the mixing coefficient on the basis of a plurality of generated samples.

5. A program for causing a computer to function as a coefficient learning device comprising:
a feature-quantity extraction unit for extracting a feature quantity of a target pixel of a student image;
a class classification unit for classifying the target pixel into a predetermined class on the basis of the extracted feature quantity;
a natural-image processing unit for performing natural-image processing including a process for restoring at least a pixel luminance level for the target pixel;
an artificial-image processing unit for performing artificial-image processing including a process for making at least an edge clear for the target pixel;
a sample generation unit for generating a sample of a normal equation using a pixel value of the target pixel subjected to the natural-image processing, a pixel value of the target pixel subjected to the artificial-image processing, a pixel value of a target pixel of a teacher image, and a predetermined mixing coefficient for each class; and
a mixing-coefficient calculation unit for calculating the mixing coefficient on the basis of a plurality of generated samples.

6. A recording medium storing the program of claim 5.

7. An image processing device comprising:
a feature-quantity extraction unit for extracting a feature quantity of a target pixel of an input image;
a class classification unit for classifying the target pixel into a predetermined class on the basis of the extracted feature quantity;
a natural-image processing unit for performing natural-image processing including a process for restoring at least a pixel luminance level for the target pixel;
an artificial-image processing unit for performing artificial-image processing including a process for making at least an edge clear for the target pixel; and
a pixel generation unit for generating a pixel of an output image by mixing a pixel value of the target pixel subjected to the natural-image processing and a pixel value of the target pixel subjected to the artificial-image processing using a mixing coefficient stored in association with the class.

8. The image processing device according to claim 7, wherein the feature-quantity extraction unit extracts a wide-range feature quantity calculated on the basis of a dynamic range in a corresponding region around the target pixel in a relatively wide region, an adjacent pixel difference absolute value, and a maximum value of the adjacent pixel difference absolute value.

9. The image processing device according to claim 7, wherein the feature-quantity extraction unit
extracts a wide-range feature quantity calculated on the basis of a dynamic range in a corresponding region around the target pixel in a relatively wide region, an adjacent pixel difference absolute value, and a maximum value of the adjacent pixel difference absolute value, and
extracts a narrow-range feature quantity calculated on the basis of a greatest value among a dynamic range in a relatively wide region around the target pixel and dynamic ranges of a plurality of relatively narrow regions including the target pixel.

10. The image processing device according to claim 7, wherein the pixel generation unit
performs weighted averaging on mixing coefficients corresponding to each of the classes to which the target pixel belongs and its peripheral class by weighting the mixing coefficients according to a distance between a vector obtained from a feature quantity of the target pixel and a center vector of the peripheral class, and
generates the pixel of the output image through mixing using the mixing coefficient subjected to the weighted averaging.

11. An image processing method comprising:
extracting, by a feature-quantity extraction unit, a feature quantity of a target pixel of an input image;
classifying, by a class classification unit, the target pixel into a predetermined class on the basis of the extracted feature quantity;
performing, by a natural-image processing unit, natural-image processing including a process for restoring at least a pixel luminance level for the target pixel;
performing, by an artificial-image processing unit, artificial-image processing including a process for making at least an edge clear for the target pixel; and
generating, by a pixel generation unit, a pixel of an output image by mixing a pixel value of the target pixel subjected to the natural-image processing and a pixel value of the target pixel subjected to the artificial-image processing using a mixing coefficient stored in association with the class.

12. A program for causing a computer to function as an image processing device comprising:
a feature-quantity extraction unit for extracting a feature quantity of a target pixel of an input image;
a class classification unit for classifying the target pixel into a predetermined class on the basis of the extracted feature quantity;
a natural-image processing unit for performing natural-image processing including a process for restoring at least a pixel luminance level for the target pixel;
an artificial-image processing unit for performing artificial-image processing including a process for making at least an edge clear for the target pixel; and
a pixel generation unit for generating a pixel of an output image by mixing a pixel value of the target pixel subjected to the natural-image processing and a pixel value of the target pixel subjected to the artificial-image processing using a mixing coefficient stored in association with the class.

13. A recording medium storing the program of claim 12.
